(19) United States
(12) Patent Application Publication
(10) Pub. No.: US 2024/0089986 A1
(43) Pub. Date: Mar. 14, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/272,711

(22) PCT Filed: Jan. 18, 2021
(86) PCT No.: PCT/JP2021/001518

§ 371 Date: Jul. 17, 2023

(51) Int. Cl. H04W 72/232; H04L 1/08; H04W 72/0446

(52) U.S. Cl. CPC H04W 72/232; H04L 1/08; H04W 72/0446

(57) ABSTRACT

A terminal according to an aspect of the present disclosure includes a control section that determines whether two physical downlink control channel (PDCCH) candidates out of a plurality of PDCCH candidates can be allocated, and a receiving section that receives the two PDCCH candidates, when it is determined that the two PDCCH candidates can be allocated. The two PDCCH candidates are present within a same slot or a same span. The two PDCCH candidates are associated with two search space sets. The two PDCCH candidates are linked to each other. When it is determined that the two PDCCH candidates cannot be allocated, the control section determines whether one or more PDCCH candidates out of the plurality of PDCCH candidates can be allocated. According to an aspect of the present disclosure, PDCCH candidates can be appropriately determined.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Repetition of a physical downlink control channel (PDCCH) is under study.

However, how to determine PDCCH candidates for a plurality of repetitions for a limit (maximum number) is not yet made clear. Unless the PDCCH candidates are appropriately determined, throughput may be reduced or communication quality may be deteriorated.

In view of this, the present disclosure has one object to provide a terminal, a radio communication method, and a base station for appropriately determining the PDCCH candidates.

### Solution to Problem

A terminal according to an aspect of the present disclosure includes a control section that determines whether two physical downlink control channel (PDCCH) candidates out of a plurality of PDCCH candidates can be allocated, and a receiving section that receives the two PDCCH candidates, when it is determined that the two PDCCH candidates can be allocated. The two PDCCH candidates are present within a same slot or a same span. The two PDCCH candidates are associated with two search space sets. The two PDCCH candidates are linked to each other. When it is determined that the two PDCCH candidates cannot be allocated, the control section determines whether one or more PDCCH candidates out of the plurality of PDCCH candidates can be allocated.

### Advantageous Effects of Invention

According to an aspect of the present disclosure, PDCCH candidates can be appropriately determined.

### BRIEF DESCRIPTION OF DRAWINGS

FIGS. 1A and 1B are each a diagram to show an example of a maximum number of monitored PDCCH candidates.

FIGS. 2A and 2B are each a diagram to show an example of a maximum number of non-overlapped CCEs.

FIG. 3 is a diagram to show an example of a first embodiment.

FIG. 4 is a diagram to show an example of aspect 2-1.

FIG. 5 is a diagram to show an example of aspect 2-2.

FIGS. 6A and 6B are each a diagram to show an example of aspect 2-3.

FIGS. 7A and 7B are each a diagram to show an example of aspect 2-4.

FIGS. 8A and 8B are each a diagram to show an example of aspect 3-1.

FIGS. 9A and 9B are each a diagram to show an example of aspect 3-2.

FIGS. 10A and 10B are each a diagram to show an example of a fourth embodiment.

FIG. 11 is a diagram to show an example of a schematic structure of a radio communication system according to one embodiment.

FIG. 12 is a diagram to show an example of a structure of a base station according to one embodiment.

FIG. 13 is a diagram to show an example of a structure of a user terminal according to one embodiment.

FIG. 14 is a diagram to show an example of a hardware structure of the base station and the user terminal according to one embodiment.

### DESCRIPTION OF EMBODIMENTS

### (TCI, Spatial Relation, QCL)

For NR, control of reception processing (for example, at least one of reception, demapping, demodulation, and decoding) and transmission processing (for example, at least one of transmission, mapping, precoding, modulation, and coding) in a UE regarding at least one of a signal and a channel (which may be referred to as a signal/channel) based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (that is, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (indicated) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X for the TCI state may mean an RS in the QCL type X relation with (the DMRS for) a certain channel/signal, and the RS may be referred to as a QCL source of the QCL type X for the TCI state.

### (Multi-TRP)

In NR, a scheme in which one or a plurality of transmission/reception points (TRPs) (multi-TRP, multi TRPs (MTRP)) perform DL transmission to the UE by using one or a plurality of panels (multi panel) is under study. A scheme in which the UE performs UL transmission to one or a plurality of TRPs by using one or a plurality of panels is also under study.

Note that the plurality of TRPs may correspond to the same cell identifier (ID), or may correspond to different cell IDs. The cell ID may be a physical cell ID, or may be a virtual cell ID.

The multi TRPs (for example, TRPs #1 and #2) are connected by an ideal/non-ideal backhaul, and information, data, and the like may be exchanged therebetween. Different code words (CWs) and different layers may be transmitted from respective TRPs of the multi TRPs. As one mode of multi-TRP transmission, non-coherent joint transmission (NCJT) may be used.

In NCJT, for example, TRP #1 performs modulation mapping of a first code word and performs layer mapping to transmit a first PDSCH by using first precoding for a first number of layers (for example, two layers). TRP #2 performs modulation mapping of a second code word and performs layer mapping to transmit a second PDSCH by using second precoding for a second number of layers (for example, two layers).

Note that it may be defined that a plurality of PDSCHs (multi PDSCHs) subjected to NCJT partially or entirely overlap in at least one of time and frequency domains. In other words, the first PDSCH from the first TRP and the second PDSCH from the second TRP may overlap in at least one of the time and frequency resources.

It may be assumed that these first PDSCH and second PDSCH are not in a quasi-co-location (QCL) relationship (not quasi-co-located). Reception of the multi PDSCHs may be interpreted as simultaneous reception of PDSCHs that are not of a certain QCL type (for example, QCL type D).

The plurality of PDSCHs (which may be referred to as multi PDSCHs (multiple PDSCHs)) from the multi TRPs may be scheduled using one DCI (single DCI, single PDCCH) (single master mode, single-DCI based multi-TRP). Each of the plurality of PDSCHs from the multi TRPs may be scheduled using a respective one of a plurality of DCIs (multi DCI, multi PDCCH (multiple PDCCH)) (multi master mode, multi-DCI based multi-TRP).

In URLLC for the multi TRPs, support of PDSCH (transport block (TB) or codeword (CW)) repetition across the multi TRPs is under study. Support of repetition schemes (URLLC scheme, for example, schemes 1, 2a, 2b, 3, and 4) across the multi TRPs in the frequency domain, the layer (space) domain, or the time domain is under study. In scheme 1, the multi PDSCHs from the multi TRPs are subjected to space division multiplexing (SDM). In schemes 2a and 2b, the PDSCHs from the multi TRPs are subjected to frequency division multiplexing (FDM). In scheme 2a, the redundancy version (RV) is the same for the multi TRPs. In scheme 2b, the RV may be the same or may be different for the multi TRPs. In schemes 3 and 4, the multi PDSCHs from the multi TRPs are subjected to time division multiplexing (TDM). In scheme 3, the multi PDSCHs from the multi TRPs are transmitted in one slot. In scheme 4, the multi PDSCHs from the multi TRPs are transmitted in different slots.

According to the multi-TRP scenario as described above, more flexible transmission control using a channel having satisfactory quality can be performed.

In order to support multi-TRP transmission within a cell (“intra-cell”, having the same cell ID) and between cells (“inter-cell”, having different cell IDs) based on a plurality of PDCCHs, in RRC configuration information for linking a plurality of pairs of PDCCHs and PDSCHs having a plurality of TRPs, one control resource set (CORESET) in PDCCH configuration information (PDCCH-Config) may correspond to one TRP.

When at least one of the following conditions 1 and 2 is satisfied, the UE may determine the multi-DCI based multi-TRP. In this case, the TRP may be interpreted as a CORESET pool index.

### [Condition 1]

One CORESET pool index is configured.

### [Condition 2]

Two different values (for example, 0 and 1) of the CORESET pool index are configured.

When the following condition is satisfied, the UE may determine the single-DCI based multi-TRP. In this case, two TRPs may be interpreted as two TCI states indicated by a MAC CE/DCI.

### [Condition]

In order to indicate one or two TCI states for one code point of a TCI field in the DCI, “Enhanced TCI States Activation/Deactivation for UE-specific PDSCH MAC CE” is used.

The DCI for common beam indication may be a UE-specific DCI format (for example, a DL DCI format (for example, 1_1, 1_2), a UL DCI format (for example, 0_1, 0_2)), or may be a UE-group common DCI format.

### (Multi TRP PDCCH)

For reliability of multi TRP PDCCH based on a non-single frequency network (SFN), the following is under study.
Coding/rate matching is based on one repetition, and the same coding bit is repeated in other repetitions.
Each repetition has the same number of control channel elements (CCEs) and the same coding bit, and corresponds to the same DCI payload.
Two or more PDCCH candidates are explicitly linked to each other. The UE is informed of the link before decoding.

The following choices 1-2, 1-3, 2, and 3 for PDCCH repetition are under study.

### [Choice 1-2]

Each of two sets of PDCCH candidates (in a given search space (SS) set) is associated with a respective one of two TCI states of the CORESET. Here, the PDCCH repetition in the same CORESET, the same SS set, and different monitoring occasions is used.

### [Choice 1-3]

Each of two sets of PDCCH candidates is associated with a respective one of two SS sets. Both of the SS sets are associated with the CORESET, and each SS set is associated with only one TCI state of the CORESET. Here, the same CORESET and two SS sets are used.

### [Choice 2]

One SS set is associated with two different CORESETs.

### [Choice 3]

Each of two SS sets is associated with a respective one of two CORESETs.

In this manner, a scheme is under study in which two PDCCH candidates in two SS sets for the PDCCH repetition are supported, and the two SS sets are explicitly linked.

### (Determination of PDCCH Candidate Allocation)

In Rel-15 NR, for a common search space (CSS), a network (NW) ensures no occurrence of overbooking (excessive allocation). The UE does not assume configuration of a CCS set that causes a corresponding total number or the number per scheduled cell regarding the PDCCH candidates and non-overlapped control channel elements (CCEs) monitored per slot to exceed a corresponding maximum number per slot.

In Rel-15 NR, for a secondary cell (SCell), the network (NW) ensures no occurrence of overbooking based on a case without carrier aggregation (CA) (non-CA). For cross carrier scheduling when a scheduling cell and a scheduled cell have a plurality of DL BWPs having the same subcarrier spacing (SCS) configuration p or scheduling of the same cell, the UE does not assume that the number of PDCCH candidates and the number of non-overlapped CCEs per slot in the SCell exceeds a corresponding number that the UE can monitor in the SCell per slot.

The UE does not assume monitoring of any PDCCH in a USS set with no PDCCH allocated for monitoring.

First, PDCCH candidates for the CSS are allocated, and subsequently PDCCH candidates for the UE-specific search space (USS) are allocated in ascending order of a search space set index (ID) (in order from the lowest search space set ID).

The CSS has a priority higher than that of the USS.

Prior to the PDCCH candidates of the USS set having a higher SS set ID, all of the PDCCH candidates of the USS set having a lower SS set ID are mapped. If all of the PDCCH candidates in a certain SS set (USS) cannot be mapped (there is not sufficient room for the PDCCH candidates (a remaining number of PDCCH candidates up to the maximum number) for the SS set), the PDCCH candidates in the SS set and the subsequent SS sets are dropped (not mapped). In the SS set ID order, an SS set subsequent to a certain SS set may be referred to as a subsequent SS set.

If a higher layer index is configured for each CORESET for the UE supporting the multi-PDCCH (multi-DCI) based multi-TRP transmission, the UE may support the following principle for the maximum number of BDs and CCEs for the multi-DCI based multi-TRP transmission.

For the CORESET configured for the same TRP (same higher layer index), the maximum number of monitored PDCCH candidates per slot in a certain DL BWP need not exceed a limit M_{PDCCH}^{max,slot,μ} of Rel. 15, and the maximum number of non-overlapped CCEs need not exceed a limit C_{PDCCH}^{max,slot,μ} of Rel. 15. The higher layer index may be configured for each piece of PDCCH configuration information (PDCCH-Config) and for each CORESET. The higher layer index may correspond to the TRP.

The UE may show a capability of monitoring the PDCCH in accordance with one or more combinations (X, Y). One span may be consecutive symbols in which the UE is configured to monitor the PDCCH in one slot. Each PDCCH monitoring occasion may be present within one span. If the UE monitors the PDCCH in one cell according to the combination(s) (X, Y), the UE supports a plurality of PDCCH monitoring occasions in any symbol of one slot having a minimum time interval (separation) of X symbols between first symbols of two consecutive spans including crossing over a plurality of slots. One span starts in the first symbol in which a certain PDCCH monitoring occasion starts and ends in the last symbol in which the certain PDCCH monitoring occasion ends. The number of symbols of the span is up to Y.

A maximum number M_{PDCCH}^{max,(X,Y),μ} of monitored PDCCH candidates in one span for the combination(s) (X, Y) in the DL BWP having a subcarrier spacing (SCS) configuration μ∈{0, 1} for a single serving cell may be defined in a specification. A maximum number C_{PDCCH}^{max,(X,Y),μ} of non-overlapped CCEs in one span for the combination(s) (X, Y) in the DL BWP having a subcarrier spacing (SCS) configuration 82 {0, 1} for a single serving cell may be defined in a specification.

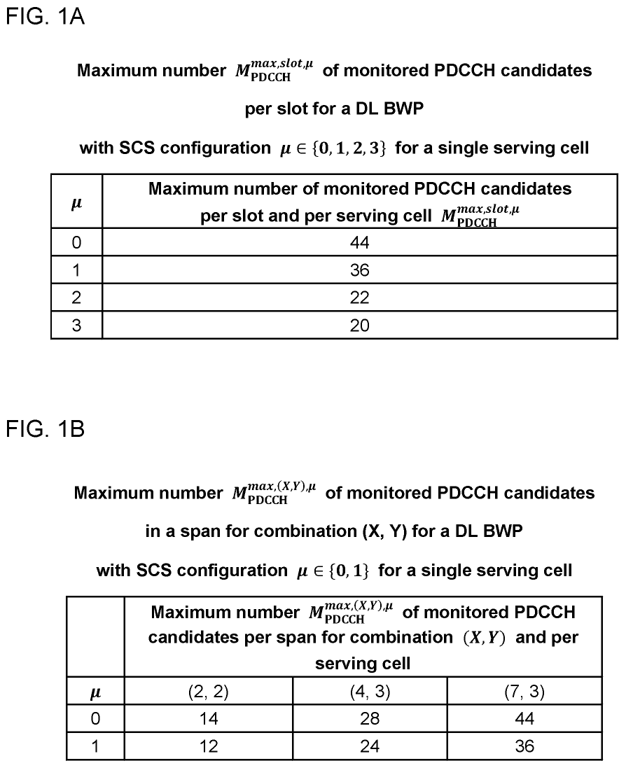

FIG. 1A shows the maximum number M_{PDCCH}^{max,slot,μ} of monitored PDCCH candidates per slot for a DL BWP with an SCS configuration μ∈{0, 1, 2, 3} for operation using a single serving cell. FIG. 1B shows the maximum number M_{PDCCH}^{max,(X,Y),μ} of monitored PDCCH candidates in one span for the combination(s) (X, Y) in a DL BWP with a subcarrier spacing (SCS) configuration μ∈{0, 1} for a single serving cell.

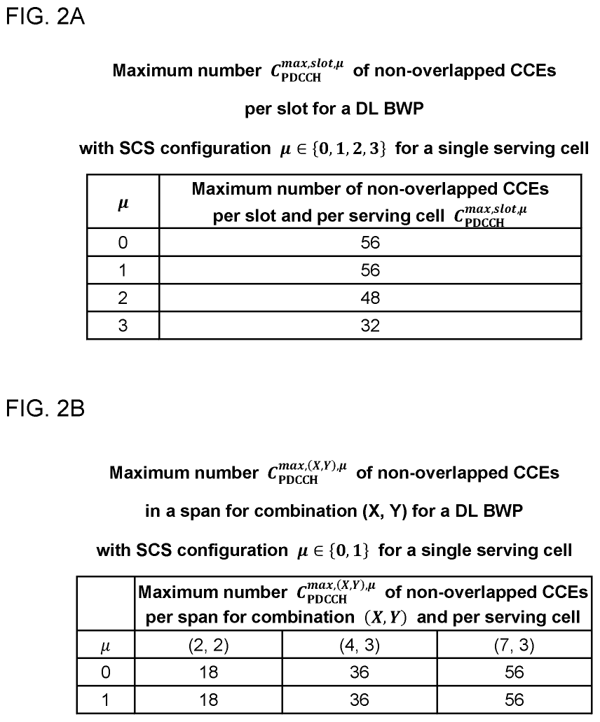

FIG. 2A shows the maximum number C_{PDCCH}^{max,slot,μ} of non-overlapped CCEs per slot for a DL BWP with an SCS configuration μ∈{0, 1, 2, 3} for operation using a single serving cell. FIG. 2B shows the maximum number M_{PDCCH}^{max,(X,Y),μ} of non-overlapped CCEs in one span for the combination(s) (X, Y) in a DL BWP with a subcarrier spacing (SCS) configuration μ∈{0, 1} for a single serving cell.

When the CCEs for the PDCCH candidates correspond to different CORESET indexes or different first symbols for reception of the respective PDCCH candidates, the CCEs do not overlap.

If Σ_{μ=0}³N_{cells}^{DL,μ}≤N_{cells}^{cap} and the UE is configured with N_{cells}^{DL,μ} DL cells having the DL BWP with the SCS configuration μ, the UE is not required to monitor more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per slot for each scheduled cell in the active DL BWP of the scheduling cell. N_{cells}^{cap} may be a value of capability information (pdcch-BlindDetectionCA) provided by the UE, or may be the number of configured DL cells.

Two PDCCH candidates (repetitions) having linkage (combination, coordination) may be decoded by the UE using soft-combining. Regarding how to count up to the limit of the BDs/CCEs, the following assumptions are under study.

### [Assumption 0]

In the BD limit, regarding complexity relating to RE demapping/demodulation, two units are required.

### [Assumption 0-1]

In the BD limit, regarding complexity relating to decoding, one or more units are required. The UE only decodes combined PDCCH candidates without decoding individual PDCCH candidates. The expression “or more” is provided because soft-combining has additional complexity relating to storage. In this case, blockage may affect performance (not separated decoding). In this case, it is implied that a base station (gNB) needs to constantly transmit both of the PDCCH candidates (in other words, the base station cannot select only one of them).

### [Assumption 0-2]

In the BD limit, regarding complexity relating to decoding, two units are required. The UE decodes individual PDCCH candidates. For the BD, soft-combining is not taken into consideration.

### [Assumption 0-3]

In the BD limit, regarding complexity relating to decoding, two or more units are required. The UE decodes the first PDCCH candidate and also decodes combined candidates. In this case, if the first PDCCH candidate is blocked (due to PDCCH blocking or due to blockage), (in addition to first decoding) second decoding is affected. In this case, it is implied that the base station (gNB) cannot select transmission of only the DCI in the second PDCCH candidate.

### [Assumption 0-4]

In the BD limit, regarding complexity relating to decoding, three units are required. The UE individually decodes each PDCCH candidate and also decodes combined candidates.

In a case of the PDCCH repetition using soft-combining, when counting is performed up to the limit of the BDs/CCEs, linkage between two PDCCH candidates is taken into consideration. However, a procedure of PDCCH overbooking (PDCCH candidate allocation) is not yet made clear.

In view of this, the inventors of the present invention came up with the idea of a method of counting/allocation of PDCCH candidates.

Embodiments according to the present disclosure will be described in detail with reference to the drawings as follows. The radio communication methods according to respective embodiments may each be employed individually, or may be employed in combination.

In the present disclosure, “A/B/C” and “at least one of A, B, and C” may be interchangeably interpreted. In the present disclosure, a cell, a serving cell, a CC, a carrier, a BWP, a DL BWP, a UL BWP, an active DL BWP, an active UL BWP, and a band may be interchangeably interpreted. In the present disclosure, an index, an ID, an indicator, and a resource ID may be interchangeably interpreted. In the present disclosure, to support, to control, to be able to control, to operate, and to be able to operate may be interchangeably interpreted.

In the present disclosure, configure, activate, update, indicate, enable, specify, and select may be interchangeably interpreted.

In the present disclosure, link, associate, correspond, map, repeat, and relate may be interchangeably interpreted. In the present disclosure, allocate, assign, monitor, and map may be interchangeably interpreted.

In the present disclosure, the higher layer signaling may be, for example, any one of Radio Resource Control (RRC) signaling, Medium Access Control (MAC) signaling, broadcast information, and the like, or a combination of these. In the present disclosure, RRC, RRC signaling, an RRC parameter, a higher layer, a higher layer parameter, an RRC information element (IE), and an RRC message may be interchangeably interpreted.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, a MAC CE and an activation/deactivation command may be interchangeably interpreted.

In the present disclosure, a beam, a spatial domain filter, a space setting, a TCI state, a UL TCI state, a unified TCI state, a unified beam, a common TCI state, a common beam, a TCI assumption, a QCL assumption, a QCL parameter, a spatial domain reception filter, a UE spatial domain reception filter, a UE receive beam, a DL beam, a DL receive beam, DL precoding, a DL precoder, a DL-RS, an RS of QCL type D for a TCI state/QCL assumption, an RS of QCL type A for a TCI state/QCL assumption, spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with QCL type X, a DL-RS having QCL type X, a source of a DL-RS, an SSB, a CSI-RS, and an SRS may be interchangeably interpreted.

In the present disclosure, a panel, an Uplink (UL) transmission entity, a TRP, a spatial relation, a control resource set (CORESET), a PDSCH, a code word, a base station, an antenna port of a certain signal (for example, a demodulation reference signal (DMRS) port), an antenna port group of a certain signal (for example, a DMRS port group), a group for multiplexing (for example, a code division multiplexing (CDM) group, a reference signal group, a CORESET group), a CORESET pool, a CORESET subset, a CW, a redundancy version (RV), and a layer (a MIMO layer, a transmission layer, a spatial layer) may be interchangeably interpreted. A panel Identifier (ID) and a panel may be interchangeably interpreted. In the present disclosure, a TRP ID and a TRP may be interchangeably interpreted.

In the present disclosure, a TRP, a transmission point, a panel, a DMRS port group, a CORESET pool, and one of two TCI states associated with one code point of a TCI field may be interchangeably interpreted.

In the present disclosure, a single TRP, a single-TRP system, single-TRP transmission, and a single PDSCH may be interchangeably interpreted. In the present disclosure, multi TRPs, a multi-TRP system, multi-TRP transmission, and multi PDSCHs may be interchangeably interpreted. In the present disclosure, a single DCI, a single PDCCH, single-DCI based multi-TRP, and activation of two TCI states in at least one TCI code point may be interchangeably interpreted.

In the present disclosure, a single TRP, a channel using a single TRP, a channel using one TCI state/spatial relation, no enabling of multi TRPs by RRC/DCI, no enabling of a plurality of TCI states/spatial relations by RRC/DCI, and no configuration of one CORESET pool index (CORESETPoolIndex) value for any of the CORESETs and no mapping of any code point of a TCI field to two TCI states may be interchangeably interpreted.

In the present disclosure, multi TRPs, a channel using multi TRPs, a channel using a plurality of TCI states/spatial relations, enabling of multi TRPs by RRC/DCI, enabling of a plurality of TCI states/spatial relations by RRC/DCI, and at least one of single-DCI based multi-TRP and multi-DCI based multi-TRP may be interchangeably interpreted. In the present disclosure, multi-DCI based multi-TRP and configuration of one CORESET pool index (CORESETPoolIndex) value for the CORESET may be interchangeably interpreted. In the present disclosure, single-DCI based multi-TRP and mapping of at least one code point of a TCI field to two TCI states may be interchangeably interpreted.

In the present disclosure, TRP #1 (first TRP) may correspond to CORESET pool index=0, or may correspond to the first TCI state of two TCI states corresponding to one code point of a TCI field. TRP #2 (second TRP) TRP #1 (first TRP) may correspond to CORESET pool index=1, or may correspond to the second TCI state of two TCI states corresponding to one code point of a TCI field.

In the present disclosure, a DMRS, a DMRS port, and an antenna port may be interchangeably interpreted.

In the present disclosure, the number of monitored PDCCH candidates and the number of blind decodings (blind detections (BDs)) may be interchangeably interpreted. The number of non-overlapped CCEs, the number of CCEs for channel estimation, and the number of CCEs may be interchangeably interpreted.

In the present disclosure, a limit, an upper limit, a restriction, and a maximum number may be interchangeably interpreted.

In the present disclosure, a slot, a span, consecutive symbols, and time domain resources may be interchangeably interpreted.

### (Radio Communication Method)

In consideration of allocation of the PDCCH candidates being performed for each slot/span, either the following assumption 1 or 2 may be assumed.

### [Assumption 1]

A plurality of PDCCH candidates for repetition are present in the same (one) slot/span.

For assumption 1, in consideration of the plurality of PDCCH candidates being allocated in a unit of SS set(s), either of the following assumptions 1-1 or 1-2 is assumed.

### [[Assumption 1-1]]

The plurality of PDCCH candidates are present in the same (one) SS set.

### [[Assumption 1-2]]

The plurality of PDCCH candidates are present in different (a plurality of) SS sets.

### [Assumption 2]

A plurality of PDCCH candidates for repetition are present in different (a plurality of) slots/spans.

Linkage between two SS sets/PDCCH candidates may be defined in a specification, or may be configured.

A fact that the SS sets/the PDCCH candidates/the PDCCH candidates in the SS sets can be allocated, a fact that there is sufficient room for the PDCCH candidates/non-overlapped CCEs for the SS sets/the PDCCH candidates/the PDCCH candidates in the SS sets, a fact that there is a remaining number of PDCCH candidates/non-overlapped CCEs up to the maximum number for the SS sets/the PDCCH candidates/the PDCCH candidates in the SS sets, and a fact that there are sufficient PDCCH candidates/non-overlapped CCEs for the SS sets/the PDCCH candidates/the PDCCH candidates in the SS sets may be interchangeably interpreted.

### First Embodiment

In assumption 1-1 (in a case where a plurality of PDCCH candidates are present in the same (one) slot/span and the plurality of PDCCH candidates are present in the same (one) SS set), for one SS set, the procedure of counting up to the maximum number of PDCCH candidates that can be monitored by the UE (procedure of allocation of the PDCCH candidates) may conform to the following.

Two PDCCH candidates having linkage may be counted as 1/2/3/4 (at least one of 1, 2, 3, and 4). A plurality of values out of 1/2/3/4 may be supported. The support of the plurality of values may be dependent upon at least one of a configuration and a UE capability. For example, according to the existing procedure, two PDCCH candidates having linkage are counted as 2.

The present embodiment may be applied to choice 1-2/choice 2 described above.

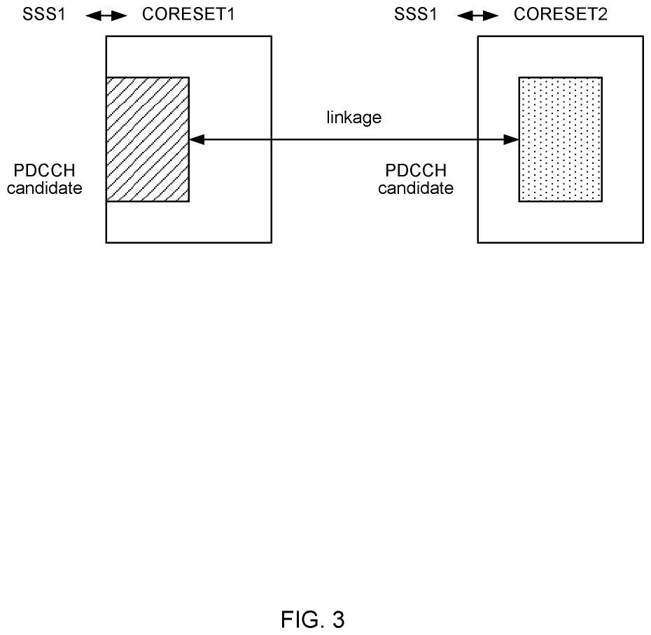

In the example of FIG. 3, regarding CORESETs 1 and 2, a search space set (SSS1) is associated with CORESET 1. The PDCCH candidate in CORESET 1 and the PDCCH candidate in CORESET 2 have linkage. The two PDCCH candidates are counted as 1/2/3/4. In accordance with the method, for one SS set, the PDCCH candidates that can be monitored by the UE may be counted up to the maximum number.

According to the present embodiment, the plurality of PDCCH candidates present in the same (one) slot/span and present in the same (one) SS set can be appropriately counted/allocated.

### Second Embodiment

In assumption 1-2 (in a case where a plurality of PDCCH candidates are present in the same (one) slot/span and the plurality of PDCCH candidates are present in different (a plurality of) SS sets), for two SS sets having linkage, the procedure of counting up to the maximum number of PDCCH candidates that can be monitored by the UE (procedure of allocation of the PDCCH candidates) may conform to any one of the following aspects 2-1 to 2-4.

### <<Aspect 2-1>>

Two PDCCH candidates in two SS sets are independently counted and independently allocated (the same as in the existing procedure).

In a case of counting for the SS set having the lower ID out of the two SS sets, when one PDCCH candidate is linked to another PDCCH candidate, the number of PDCCH candidates may be counted as 1.

In a case of counting for the SS set having the higher ID, when one PDCCH candidate is linked to another PDCCH candidate, the number of PDCCH candidates may be counted as 1. In this case, in consideration of additional complexity of soft-combining, the number of PDCCH candidates may be counted as 2 or 3. A plurality of values out of 1/2/3 may be supported. The support of the plurality of values may be dependent upon at least one of a configuration and a UE capability.

The PDCCH candidates may be allocated in order (ascending order) of the SS set ID from the lowest to the highest (the same as in the existing procedure).

If there are not sufficient PDCCH candidates (room for the PDCCH candidates, a remaining number of PDCCH candidates up to the maximum number) for a certain SS set, all of the PDCCH candidates in the SS set need not be allocated (may be dropped) (the same as in the existing procedure).

In this case, in some cases, the first PDCCH candidate is allocated and the second PDCCH candidate is dropped (not allocated).

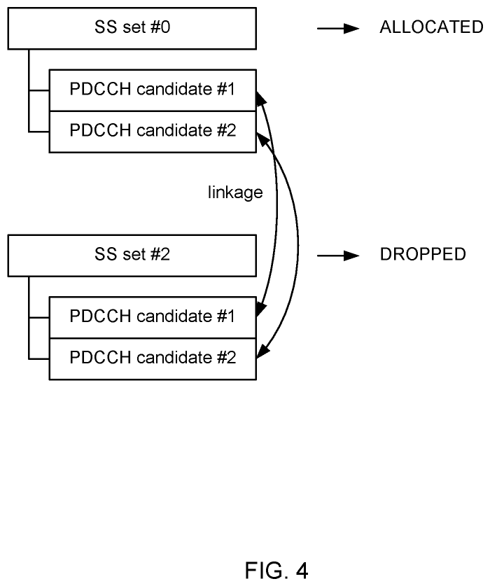

In the example of FIG. 4, PDCCH candidates #1 and #2 in an SS set (SS set #0) having SS set ID=0 and PDCCH candidates #1 and #2 in an SS set (SS set #2) having SS set ID=2 are configured. PDCCH candidate #1 in SS set #0 and PDCCH candidate #1 in SS set #2 have linkage, and PDCCH candidate #2 in SS set #0 and PDCCH candidate #2 in SS set #2 have linkage. In ascending order of the SS set ID, PDCCH candidates #1 and #2 in SS set #0 are allocated. Subsequently, if there is not room for allocating PDCCH candidates #1 and #2 in SS set #2 (a remaining number of PDCCH candidates up to the maximum number) through comparison between the count of PDCCH candidates to be allocated and the maximum number, PDCCH candidates #1 and #2 in SS set #2 are dropped (not allocated).

### <<Aspect 2-2>>

Two PDCCH candidates in two SS sets are independently counted and independently allocated. In the PDCCH candidate allocation procedure, the priority of the linked SS sets/PDCCH candidates can be increased.

In the PDCCH candidate allocation procedure, when a plurality of PDCCH candidates in one SS set are allocated, the linked PDCCH candidates/SS sets of later time (associated with a higher ID) may be allocated using a higher priority. The allocation of the PDCCH candidates may conform to either the following allocation method 1 or 2.

### [Allocation Method 1]

All of the PDCCH candidates in the linked SS sets may be allocated using a higher priority.

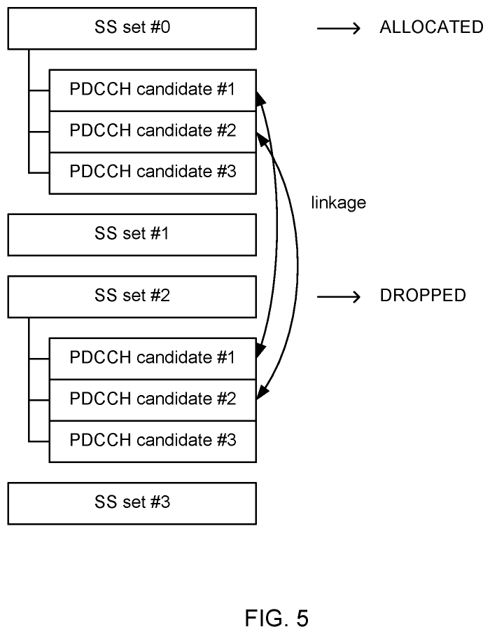

In the example of FIG. 5, SS sets #0 to #3 (SS sets having SS set ID=0 to 3) are configured, PDCCH candidates #1 to #3 are configured in SS set #0, and PDCCH candidates #1 to #3 are configured in SS set #2. PDCCH candidate #1 in SS set #0 and PDCCH candidate #1 in SS set #2 have linkage, and PDCCH candidate #2 in SS set #0 and PDCCH candidate #2 in SS set #2 have linkage. For example, in accordance with allocation method 1 (descending order of the priority, and subsequently ascending order of the SS set ID), allocation is performed in order of SS set #0, SS set #2, SS set #1, and SS set #3. If there is not room for allocating the PDCCH candidates (a remaining number of PDCCH candidates up to the maximum number) in SS set #2 through comparison between the count of PDCCH candidates to be allocated and the maximum number after the PDCCH candidates in SS set #0 are allocated, the PDCCH candidates in SS set #2 are dropped (not allocated).

### [Allocation Method 2]

(Only) the PDCCH candidates having linkage may be allocated using a higher priority. For example, in accordance with allocation method 2 (the PDCCH candidates having linkage, and subsequently ascending order of the SS set ID), in the example of FIG. 5, allocation is performed in order of SS set #0, PDCCH candidates #1 and #2 in SS set #2, SS set #1, PDCCH candidates #1 and #2 in SS set #2, and SS set #3. If there is not room for allocating the PDCCH candidates (a remaining number of PDCCH candidates up to the maximum number) in SS set #2 through comparison between the count of PDCCH candidates to be allocated and the maximum number after the PDCCH candidates in SS set #0 are allocated, the PDCCH candidates in SS set #2 are dropped (not allocated).

In the same priority, the PDCCH candidates may be allocated in order (ascending order) of the SS set ID from the lowest to the highest (the same as in the existing procedure).

Other configurations of aspect 2-2 may be similar to those of aspect 2-1.

In this case, in some cases, the first PDCCH candidate is allocated and the second PDCCH candidate is dropped (not allocated).

### <<Aspect 2-3>>

Two SS sets having linkage are counted together (jointly) and allocated together. All of the PDCCH candidates in two SS sets may be counted together and allocated together. This aspect is preferable when all of the PDCCH candidates in two SS sets are configured with linkage. This aspect may be applied when all or some of the PDCCH candidates are configured with linkage.

In a case of counting for an SS set having a lower ID, an SS set linked to the SS set may be counted together. If one PDCCH candidate is linked to another PDCCH candidate, the number of PDCCH candidates to be allocated may be counted as 1/2/3/4. A plurality of values out of 1/2/3/4 may be supported. The support of the plurality of values may be dependent upon at least one of a configuration and a UE capability. If all of the PDCCH candidates in two SS sets can be allocated, all of the PDCCH candidates in both of the two SS sets need not be allocated. If there are not sufficient PDCCH candidates (room for the PDCCH candidates, a remaining number of PDCCH candidates up to the maximum number) for all of the PDCCH candidates in two SS sets, all of the PDCCH candidates in both of the two SS sets need not be allocated (may be dropped).

In a case of counting for an SS set having a higher ID, if the PDCCH candidates in the SS set are linked to previously allocated PDCCH candidates, the number of PDCCH candidates to be allocated may be counted as 0.

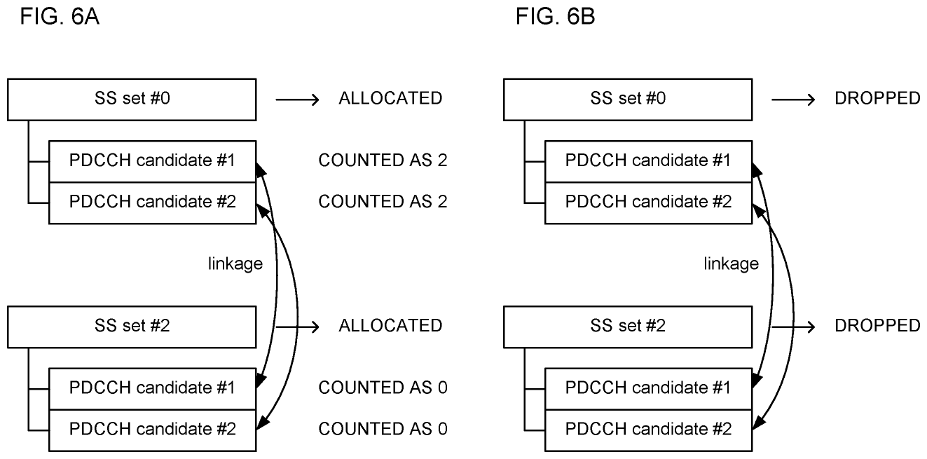

In this case, all of (the PDCCH candidates in) the two SS sets having linkage may be allocated. In the example of FIG. 6A, PDCCH candidates #1 and #2 in SS set #0 and PDCCH candidates #1 and #2 in SS set #2 are configured. PDCCH candidate #1 in SS set #0 and PDCCH candidate #1 in SS set #2 have linkage, and PDCCH candidate #2 in SS set #0 and PDCCH candidate #2 in SS set #2 have linkage. PDCCH candidate #1 in SS set #0 is counted as 2. PDCCH candidate #1 in SS set #2 linked to PDCCH candidate #1 in SS set #0 is not counted. PDCCH candidate #2 in SS set #0 is counted as 2. PDCCH candidate #2 in SS set #2 linked to PDCCH candidate #2 in SS set #0 is not counted. When the count of PDCCH candidates #1 and #2 in SS set #0 and PDCCH candidates #1 and #2 in SS set #2 is equal to or less than the maximum number (there is room for PDCCH candidates #1 and #2 in SS set #0 and PDCCH candidates #1 and #2 in SS set #2), all of these PDCCH candidates are allocated.

In this case, all of (the PDCCH candidates in) the two SS sets having linkage may be dropped. In the example of FIG. 6B, PDCCH candidate #1 in SS set #0 and PDCCH candidate #1 in SS set #2 have linkage, and PDCCH candidate #2 in SS set #0 and PDCCH candidate #2 in SS set #2 have linkage. When the count of PDCCH candidates #1 and #2 in SS set #0 and PDCCH candidates #1 and #2 in SS set #2 exceeds the maximum number (there is not room for PDCCH candidates #1 and #2 in SS set #0 and PDCCH candidates #1 and #2 in SS set #2), all of these PDCCH candidates are dropped (not allocated).

### <<Aspect 2-4>>

Two PDCCH candidates having linkage are counted together and allocated together. Only the PDCCH candidates having linkage in two SS sets may be counted together and allocated together. This aspect is preferable when some (a part) of the PDCCH candidates in the two SS sets are configured with linkage, and other PDCCH candidates in the two SS sets are configured without linkage.

In a case of counting for an SS set having a lower ID, if one PDCCH candidate is linked to another PDCCH candidate, the number of PDCCH candidates to be allocated may be counted as 1/2/3/4. A plurality of values out of 1/2/3/4 may be supported. The support of the plurality of values may be dependent upon at least one of a configuration and a UE capability. If all of PDCCH candidates in a first SS set and PDCCH candidates that are in a second SS set and are linked to the PDCCH candidates in the first SS set can be allocated, all of the PDCCH candidates in the first SS set and the PDCCH candidates that are in the second SS set and are linked to the PDCCH candidates in the first SS set may be allocated. If there are not sufficient PDCCH candidates (room for the PDCCH candidates, a remaining number of PDCCH candidates up to the maximum number) for all of the PDCCH candidates in the first SS set and the PDCCH candidates that are in the second SS set and are linked to the PDCCH candidates in the first SS set, all of the PDCCH candidates in the first SS set and the PDCCH candidates that are in the second SS set and are linked to the PDCCH candidates in the first SS set need not be allocated (may be dropped).

In a case of counting for an SS set having a higher ID, if the PDCCH candidates in the SS set are linked to previously allocated DCCH candidates, the number of PDCCH candidates to be allocated may be counted as 0.

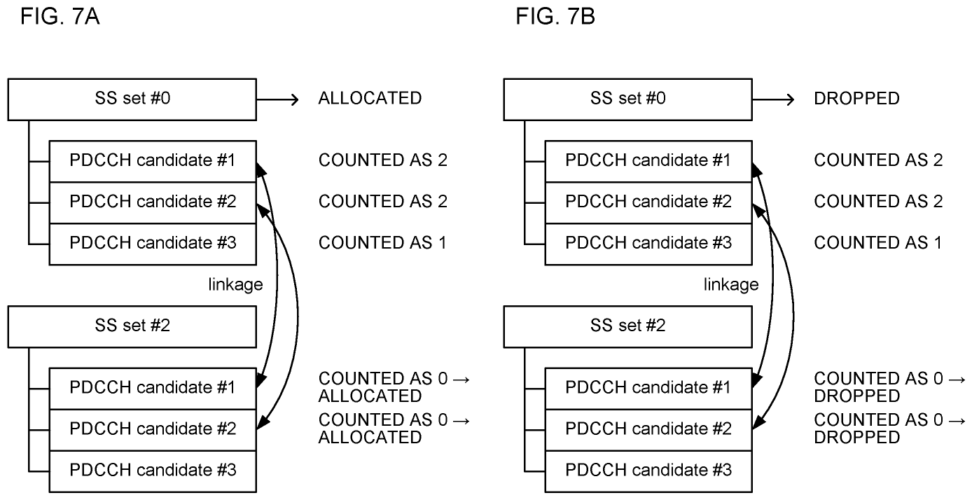

In this case, all of (the PDCCH candidates in) the two SS sets having linkage may be allocated. In the example of FIG. 7A, PDCCH candidates #1 to #3 in SS set #0 and PDCCH candidates #1 to #3 in SS set #2 are configured. PDCCH candidate #1 in SS set #0 and PDCCH candidate #1 in SS set #2 have linkage, and PDCCH candidate #2 in SS set #0 and PDCCH candidate #2 in SS set #2 have linkage. PDCCH candidate #1 in SS set #0 is allocated and has linkage, and is thus counted as 2. PDCCH candidate #1 in SS set #0 is counted as 2. PDCCH candidate #1 in SS set #2 linked to PDCCH candidate #1 in SS set #0 is not counted. PDCCH candidate #2 in SS set #0 has linkage, and is thus counted as 2. PDCCH candidate #2 in SS set #2 linked to PDCCH candidate #2 in SS set #0 is not counted. PDCCH candidate #3 in SS set #0 does not have linkage, and is thus counted as 1. The count of PDCCH candidate #3 in SS set #2 may conform to the existing procedure. When the count of PDCCH candidates #1, #2, and #3 in SS set #0 and PDCCH candidates #1 and #2 in SS set #2 is equal to or less than the maximum number (there is room for PDCCH candidates #1, #2, and #3 in SS set #0 and PDCCH candidates #1 and #2 in SS set #2), all of these PDCCH candidates are allocated.

In this case, all of (the PDCCH candidates in) the two SS sets having linkage may be dropped. In the example of FIG. 7B, PDCCH candidate #1 in SS set #0 and PDCCH candidate #1 in SS set #2 have linkage, and PDCCH candidate #2 in SS set #0 and PDCCH candidate #2 in SS set #2 have linkage. The count of PDCCH candidate #3 in SS set #2 may conform to the existing procedure. When the count of PDCCH candidates #1, #2, and #3 in SS set #0 and PDCCH candidates #1 and #2 in SS set #2 exceeds the maximum number (there is not room for PDCCH candidates #1, #2, and #3 in SS set #0 and PDCCH candidates #1 and #2 in SS set #2), all of these PDCCH candidates are dropped (not allocated).

According to the present embodiment, the plurality of PDCCH candidates present in the same (one) slot/span and present in different (a plurality of) SS sets can be appropriately counted/allocated.

### <Analysis>

According to aspects 2-3 and 2-4 described above, when two PDCCH candidates are present in the same slot/span, the PDCCH candidates in two SS sets having linkage are counted together (jointly). The PDCCH candidates are allocated or dropped at the SS set level (with the SS set being a unit). Similarly to Rel. 15/16, if two linked SS sets cannot be allocated, all of the subsequent SS sets cannot be allocated.

However, when two SS sets counted together are used, it is more likely that there is not sufficient room for the PDCCH candidates (a remaining number of PDCCH candidates up to the maximum number), in comparison to Rel. 15/16. In order to secure allocation of more PDCCH candidates, a further enhancement may be performed regarding the overbooking (PDCCH candidate allocation) procedure. The following assumption 3 may be assumed.

### [Assumption 3]

Two PDCCH candidates in two SS sets having a plurality of corresponding CORESETs are used for multi TRP PDCCH repetition.
Two PDCCH candidates/two SS sets/two CORESETs are explicitly linked to each other. The linkage may be determined according to a rule defined in a specification, or may be configured with higher layer signaling.
The two linked PDCCH candidates for repetition are present in the same slot/span.

### Third Embodiment

If both of the two linked PDCCH candidates cannot be allocated, a fallback to the existing procedure is permitted. The present embodiment may be applied to assumption 3.

The UE may conform to at least one of the following aspects 3-1 and 3-2.

### <<Aspect 3-1>>

Two SS sets (for example, SS set x and SS set y) having linkage are counted together and allocated together. This is an enhancement based on aspect 2-3.

If all of the PDCCH candidates in the two SS sets can be allocated, all of the PDCCH candidates in both of the two SS sets may be allocated.

After the two sets are allocated, the UE/base station may transfer to the following procedure 3-1-1 (reusing the existing procedure).

### [Procedure 3-1-1]

The UE/base station may determine whether the subsequent SS set of the SS set (for example, SS set x) having the lower ID out of the two SS sets can be allocated. The order of allocation/determination may be based on the order of the SS set ID from a low ID to a high ID. If there is sufficient room for the PDCCH candidates (a remaining number of PDCCH candidates up to the maximum number)/room for the non-overlapped CCEs (a remaining number of non-overlapped CCEs up to the maximum number), the subsequent SS set may be allocated.

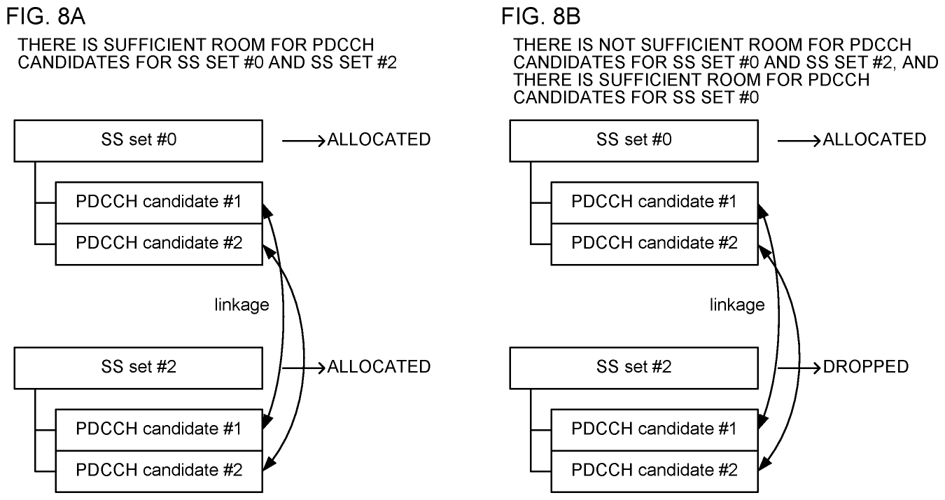

In the examples of FIGS. 8A and 8B, PDCCH candidates #1 and #2 in SS set #0 (SS set ID=0) and PDCCH candidates #1 and #2 in SS set #2 (SS set ID=2) are configured. PDCCH candidate #1 in SS set #0 and PDCCH candidate #1 in SS set #2 have linkage, and PDCCH candidate #2 in SS set #0 and PDCCH candidate #2 in SS set #2 have linkage.

In the example of FIG. 8A, if there is sufficient room for the PDCCH candidates/non-overlapped CCEs for SS sets #0 and #2, SS sets #0 and #2 are allocated.

If there is not sufficient room for the PDCCH candidates (a remaining number of PDCCH candidates up to the maximum number)/room for the non-overlapped CCEs (a remaining number of non-overlapped CCEs up to the maximum number) for all of the PDCCH candidates in the two SS sets, the UE/base station may fall back to the following existing procedure 3-1-2 (reusing the existing procedure).

### [Procedure 3-1-2]

If there is sufficient room for the PDCCH candidates (a remaining number of PDCCH candidates up to the maximum number)/room for the non-overlapped CCEs (a remaining number of non-overlapped CCEs up to the maximum number) for the PDCCH candidates in the SS set (for example, SS set x) having the lower ID out of the two SS sets, SS set x may be allocated. After SS set x is allocated, the UE/base station may determine whether the subsequent SS set of SS set x can be allocated. The order of allocation may be based on the order of the SS set ID from a low ID to a high ID. If there is sufficient room for the PDCCH candidates (a remaining number of PDCCH candidates up to the maximum number)/room for the non-overlapped CCEs (a remaining number of non-overlapped CCEs up to the maximum number), the subsequent SS set may be allocated.

In the example of FIG. 8B, if there is not sufficient room for the PDCCH candidates/non-overlapped CCEs for SS sets #0 and #2, and there is sufficient room for the PDCCH candidates/non-overlapped CCEs for the PDCCH candidates in SS set #0 (lower ID), SS set #0 is allocated and SS set #2 is dropped (not allocated).

### <<Aspect 3-2>>

Two PDCCH candidates in two SS sets (for example, SS set x and SS set y) having linkage are counted together and allocated together. This is an enhancement based on aspect 2-4.

If all of the PDCCH candidates (for example, a plurality of PDCCH candidates a) in the SS set (for example, SS set x) having the lower ID out of the two SS sets and the PDCCH candidates (for example, a plurality of PDCCH candidates b) that are in the SS set (for example, SS set y) having the higher ID and are linked to the PDCCH candidates a can be allocated, the PDCCH candidates a and the PDCCH candidates b may be allocated.

After the allocation, whether the subsequent SS set of SS set x can be allocated may be determined. The order of allocation may be based on the order of the SS set ID from a low ID to a high ID. If there is sufficient room for the PDCCH candidates (a remaining number of PDCCH candidates up to the maximum number)/room for the non-overlapped CCEs (a remaining number of non-overlapped CCEs up to the maximum number), the subsequent SS set may be allocated.

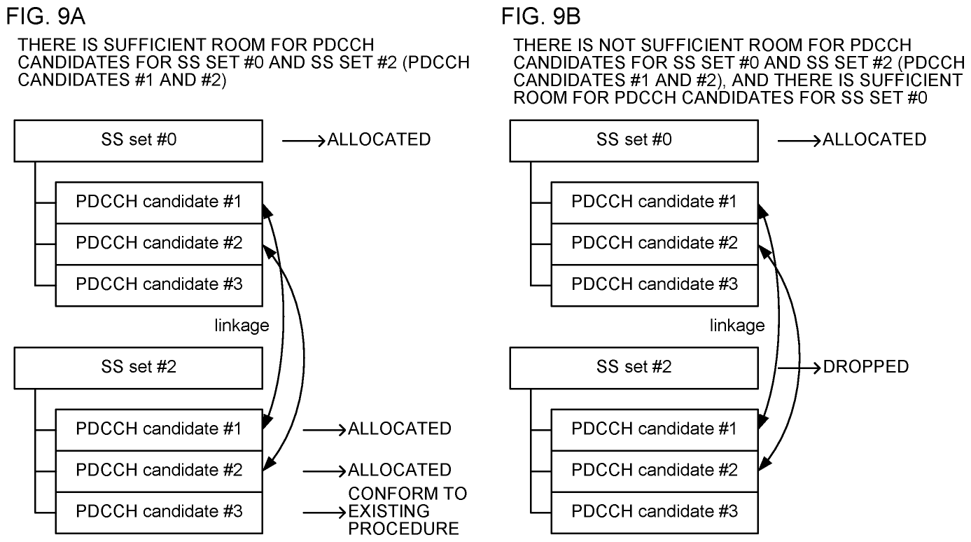

In the examples of FIGS. 9A and 9B, PDCCH candidates #1 and #2 in SS set #0 (SS set ID=0) and PDCCH candidates #1, #2, and #3 in SS set #2 (SS set ID=2) are configured. PDCCH candidate #1 in SS set #0 and PDCCH candidate #1 in SS set #2 have linkage, and PDCCH candidate #2 in SS set #0 and PDCCH candidate #2 in SS set #2 have linkage.

In the example of FIG. 9A, if there is sufficient room for the PDCCH candidates/non-overlapped CCEs for PDCCH candidates #1 and #2 in SS set #0 and PDCCH candidates #1 and #2 that are in SS set #2 and that are linked to PDCCH candidates #1 and #2 in SS set #0, PDCCH candidates #1 and #2 in SS set #0 and PDCCH candidates #1 and #2 that are in SS set #2 and that are linked to PDCCH candidates #1 and #2 in SS set #0 are allocated. PDCCH candidate #3 in SS set #2 conforms to the existing procedure.

If there is not sufficient room for the PDCCH candidates (a remaining number of PDCCH candidates up to the maximum number)/room for the non-overlapped CCEs (a remaining number of non-overlapped CCEs up to the maximum number) for all of the PDCCH candidates (for example, a plurality of PDCCH candidates a) in the SS set (for example, SS set x) having the lower ID out of the two SS sets and the PDCCH candidates (for example, a plurality of PDCCH candidates b) that are in the SS set (for example, SS set y) having the higher ID and are linked to the PDCCH candidates a, the UE/base station may fall back to the following existing procedure 3-2 (reusing the existing procedure).

### [Procedure 3-2]

If there is sufficient room for the PDCCH candidates (a remaining number of PDCCH candidates up to the maximum number)/room for the non-overlapped CCEs (a remaining number of non-overlapped CCEs up to the maximum number) for the PDCCH candidates in the SS set (for example, SS set x) having the lower ID out of the two SS sets, SS set x may be allocated. After SS set x is allocated, the UE/base station may determine whether the subsequent SS set of SS set x can be allocated. The order of allocation may be based on the order of the SS set ID from a low ID to a high ID. If there is sufficient room for the PDCCH candidates (a remaining number of PDCCH candidates up to the maximum number)/room for the non-overlapped CCEs (a remaining number of non-overlapped CCEs up to the maximum number), the subsequent SS set may be allocated.

In the example of FIG. 9B, if there is not sufficient room for the PDCCH candidates/non-overlapped CCEs for PDCCH candidates #1 and #2 in SS set #0 and PDCCH candidates #1 and #2 that are in SS set #2 and that are linked to PDCCH candidates #1 and #2 in SS set #0, and there is sufficient room for the PDCCH candidates/non-overlapped CCEs for the PDCCH candidates in SS set #0 (lower ID), SS set #0 is allocated, and SS set #2 is dropped (not allocated).

According to the present embodiment, the plurality of PDCCH candidates present in the same (one) slot/span and present in different (a plurality of) SS sets can be appropriately counted/allocated.

### Fourth Embodiment

A plurality of PDCCH candidates are allocated or dropped at the PDCCH candidate level (with the PDCCH candidate being a unit). The present embodiment may be applied to assumption 3.

The UE/base station may allocate the PDCCH candidates at the PDCCH candidate level (with the PDCCH candidate being a unit). Two PDCCH candidates having linkage may be counted together and allocated together.

In each SS set, the UE/base station may allocate the PDCCH candidates, based on the order of the PDCCH candidate ID from a low ID to a high ID.

With the order, when a PDCCH candidate not having linkage is reached, the UE/base station may determine whether the PDCCH can be allocated. If there is sufficient room for the PDCCH candidates (a remaining number of PDCCH candidates up to the maximum number)/room for the non-overlapped CCEs (a remaining number of non-overlapped CCEs up to the maximum number) for the PDCCH candidate, the PDCCH candidate may be allocated. If there is not sufficient room for the PDCCH candidates (a remaining number of PDCCH candidates up to the maximum number)/room for the non-overlapped CCEs (a remaining number of non-overlapped CCEs up to the maximum number) for the PDCCH candidate, the PDCCH candidate and the subsequent PDCCH candidates need not be allocated.

With the order, when a PDCCH candidate (for example, PDCCH candidate x) linked to another PDCCH candidate is reached, the UE/base station may determine whether the two linked PDCCH candidates can be allocated. If there is sufficient room for the PDCCH candidates (a remaining number of PDCCH candidates up to the maximum number)/room for the non-overlapped CCEs (a remaining number of non-overlapped CCEs up to the maximum number) for the two linked PDCCH candidates, the two linked PDCCH candidates may be allocated. If there is not sufficient room for the PDCCH candidates (a remaining number of PDCCH candidates up to the maximum number)/room for the non-overlapped CCEs (a remaining number of non-overlapped CCEs up to the maximum number) for the two linked PDCCH candidates, the UE/base station may conform to either the following choice 1 or 2.

### [Choice 1]

The two linked PDCCH candidates and the subsequent PDCCH candidates are not allocated.

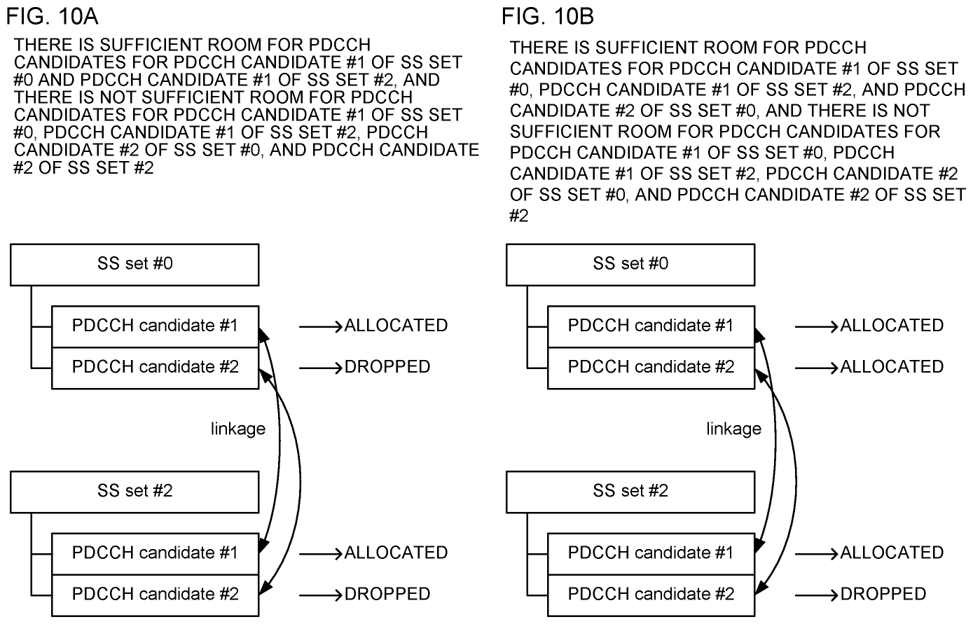

In the examples of FIGS. 10A and 10B, PDCCH candidates #1 (PDCCH candidate ID=1) and #2 (PDCCH candidate ID=2) in SS set #0 (SS set ID=0) and PDCCH candidates #1 (PDCCH candidate ID=1) and #2 (PDCCH candidate ID=2) in SS set #2 (SS set ID=2) are configured. PDCCH candidate #1 in SS set #0 and PDCCH candidate #1 in SS set #2 have linkage, and PDCCH candidate #2 in SS set #0 and PDCCH candidate #2 in SS set #2 have linkage.

In the example of FIG. 10A, if there is sufficient room for the PDCCH candidates/non-overlapped CCEs for PDCCH candidate #1 in SS set #0 and PDCCH candidate #1 that is in SS set #2 and is linked to PDCCH candidate #1 in SS set #0, and there is not sufficient room for the PDCCH candidates/non-overlapped CCEs for PDCCH candidate #1 in SS set #0, PDCCH candidate #1 that is in SS set #2 and is linked to PDCCH candidate #1 in SS set #0, PDCCH candidate #2 in SS set #0, and PDCCH candidate #2 that is in SS set #2 and is linked to PDCCH candidate #2 in SS set #0, PDCCH candidate #1 in SS set #0 and PDCCH candidate #1 in SS set #2 are allocated, and PDCCH candidate #2 in SS set #0 and PDCCH candidate #2 in SS set #2 are dropped (not allocated).

### [Choice 2]

The UE/base station determines whether the PDCCH candidate x can be allocated. If there is sufficient room for the PDCCH candidates (a remaining number of PDCCH candidates up to the maximum number)/room for the non-overlapped CCEs (a remaining number of non-overlapped CCEs up to the maximum number) for the PDCCH candidate x, the PDCCH candidate x may be allocated. After the PDCCH candidate x is allocated, the UE/base station may determine whether the subsequent PDCCH candidate of the PDCCH candidate x can be allocated, based on the order of the PDCCH candidate ID.

In the example of FIG. 10B, if there is sufficient room for the PDCCH candidates/non-overlapped CCEs for PDCCH candidate #1 in SS set #0, PDCCH candidate #1 that is in SS set #2 and is linked to PDCCH candidate #1 in SS set #0, and PDCCH candidate #2 in SS set #0, and there is not sufficient room for the PDCCH candidates/non-overlapped CCEs for PDCCH candidate #1 in SS set #0, PDCCH candidate #1 that is in SS set #2 and is linked to PDCCH candidate #1 in SS set #0, PDCCH candidate #2 in SS set #0, and PDCCH candidate #2 that is in SS set #2 and is linked to PDCCH candidate #2 in SS set #0, PDCCH candidate #1 in SS set #0, PDCCH candidate #1 in SS set #2, and PDCCH candidate #2 in SS set #0 are allocated, and PDCCH candidate #2 in SS set #2 is dropped (not allocated).

According to the present embodiment, the plurality of PDCCH candidates present in the same (one) slot/span and present in different (a plurality of) SS sets can be appropriately counted/allocated.

### Fifth Embodiment

A higher layer parameter (RRC information element)/UE capability corresponding to at least one function (characteristic, feature) in the first to fourth embodiments may be defined. The UE capability may indicate support of the function.

The UE configured with the higher layer parameter corresponding to the function may perform the function. “The UE not configured with the higher layer parameter corresponding to the function does not perform the function” may be defined.

The UE that has reported the UE capability indicating support of the function may perform the function. “The UE that has not reported the UE capability indicating support of the function does not perform the function” may be defined.

When the UE reports the UE capability indicating support of the function, and is configured with the higher layer parameter corresponding to the function, the UE may perform the function. “When the UE does not report the UE capability indicating the support of the function, or is not configured with the higher layer parameter corresponding to the function, the UE does not perform the function” may be defined.

The UE capability may indicate whether the PDCCH repetition is supported.

When both of two linked SS sets/PDCCH candidates cannot be allocated in a case of PDCCH allocation at the SS set level, the UE capability may indicate whether to support a fallback to the existing procedure (third embodiment/aspect 3-1).

When both of two linked SS sets/PDCCH candidates cannot be allocated in a case of PDCCH allocation at the SS set level, the UE capability may indicate whether to support allocation of one of the linked SS sets/PDCCH candidates (third embodiment/aspect 3-2).

The UE capability may indicate whether to support PDCCH candidate allocation at the PDCCH candidate level (fourth embodiment).

When both of two linked SS sets/PDCCH candidates cannot be allocated in a case of PDCCH allocation at the PDCCH candidate level, the UE capability may indicate whether to support allocation of one of the linked SS sets/PDCCH candidates (fourth embodiment/choice 2).

According to the present embodiment, the UE can implement the functions described above while maintaining compatibility with existing specifications.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

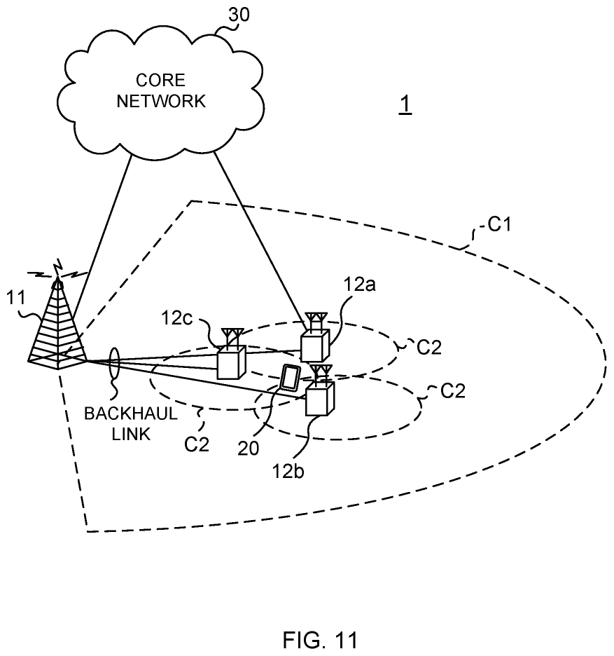

FIG. 11 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

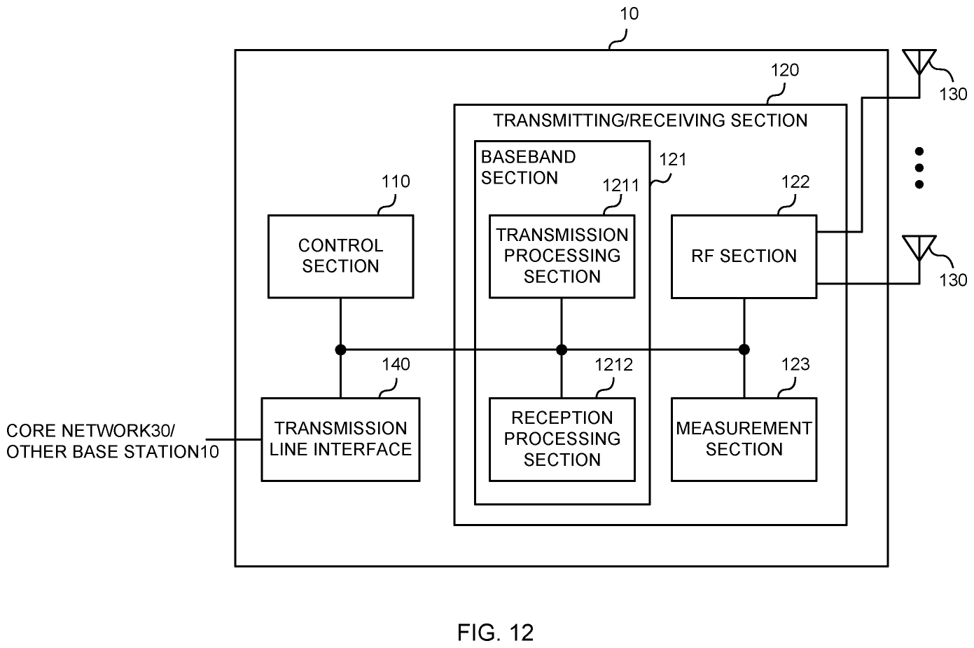

FIG. 12 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The control section 110 may determine whether two physical downlink control channel (PDCCH) candidates out of a plurality of PDCCH candidates can be allocated. The transmitting/receiving section 120 may transmit a PDCCH on at least one of the two PDCCH candidates, when it is determined that the two PDCCH candidates can be allocated. The two PDCCH candidates may be present within a same slot or a same span. The two PDCCH candidates may be associated with each of two search space sets. The two PDCCH candidates may be linked to each other. When it is determined that the two PDCCH candidates cannot be allocated, the control section 110 may determine whether one or more PDCCH candidates out of the plurality of PDCCH candidates can be allocated.

### (User Terminal)

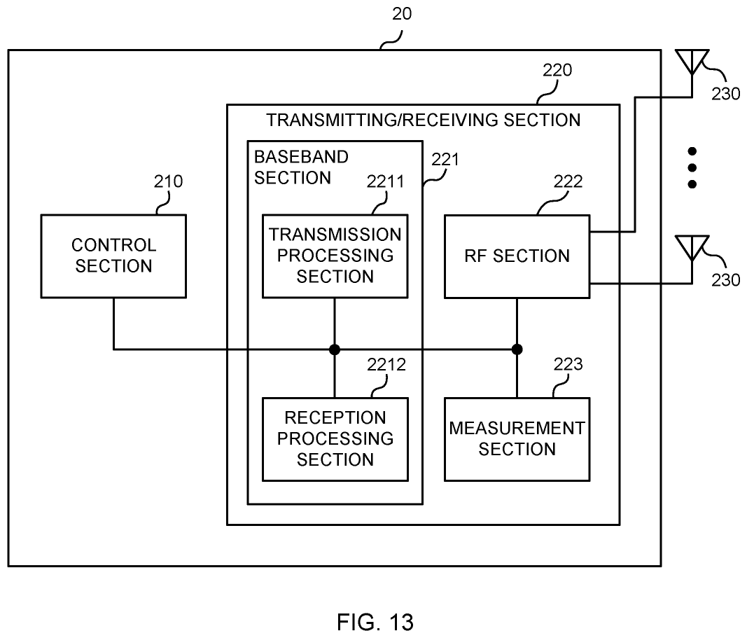

FIG. 13 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may determine whether two physical downlink control channel (PDCCH) candidates out of a plurality of PDCCH candidates can be allocated. The transmitting/receiving section 220 may receive the two PDCCH candidates, when it is determined that the two PDCCH candidates can be allocated. The two PDCCH candidates may be present within a same slot or a same span. The two PDCCH candidates may be associated with each of two search space sets. The two PDCCH candidates may be linked to each other. When it is determined that the two PDCCH candidates cannot be allocated, the control section 210 may determine whether one or more PDCCH candidates out of the plurality of PDCCH candidates can be allocated.

The one or more PDCCH candidates may be two PDCCH candidates associated with one search space set (third embodiment), or one PDCCH candidate (fourth embodiment).

The two PDCCH candidates may be associated with each of two control resource sets.

The two PDCCH candidates may be two repetitions.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

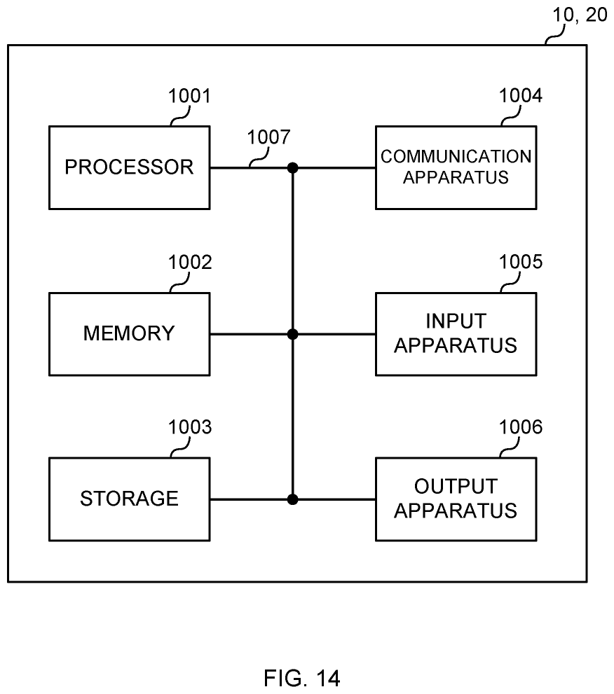

For example, a base station, a user terminal, and so on according to one embodiment of the present disclosure may function as a computer that executes the processes of the radio communication method of the present disclosure. FIG. 14 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### VARIATIONS

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Notifying of information is by no means limited to the aspects/embodiments described in the present disclosure, and other methods may be used as well. For example, notifying of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CEs).

Also, notifying of certain information (for example, notifying of “being X”) does not necessarily have to be notified explicitly, and can be notified implicitly (by, for example, not notifying this certain information or notifying another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that determines whether two physical downlink control channel (PDCCH) candidates out of a plurality of PDCCH candidates can be allocated; and
a receiving section that receives the two PDCCH candidates, when it is determined that the two PDCCH candidates can be allocated, wherein
the two PDCCH candidates are present within a same slot or a same span,
the two PDCCH candidates are associated with two search space sets,
the two PDCCH candidates are linked to each other, and
when it is determined that the two PDCCH candidates cannot be allocated, the control section determines whether one or more PDCCH candidates out of the plurality of PDCCH candidates can be allocated.

2. The terminal according to claim 1, wherein the one or more PDCCH candidates are two PDCCH candidates associated with one search space set, or one PDCCH candidate.

3. The terminal according to claim 1, wherein the two PDCCH candidates are associated with two control resource sets.

4. The terminal according to claim 1, wherein the two PDCCH candidates are two repetitions.

5. A radio communication method for a terminal comprising:
determining whether two physical downlink control channel (PDCCH) candidates out of a plurality of PDCCH candidates can be allocated; and
receiving the two PDCCH candidates, when it is determined that the two PDCCH candidates can be allocated, wherein
the two PDCCH candidates are present within a same slot or a same span,
the two PDCCH candidates are associated with two search space sets,
the two PDCCH candidates are linked to each other, and
when it is determined that the two PDCCH candidates cannot be allocated, the terminal determines whether one or more PDCCH candidates out of the plurality of PDCCH candidates can be allocated.

6. A base station comprising:
a control section that determines whether two physical downlink control channel (PDCCH) candidates out of a plurality of PDCCH candidates can be allocated; and
a transmitting section that transmits a PDCCH on at least one of the two PDCCH candidates, when it is determined that the two PDCCH candidates can be allocated, wherein
the two PDCCH candidates are present within a same slot or a same span,
the two PDCCH candidates are associated with two search space sets,
the two PDCCH candidates are linked to each other, and
when it is determined that the two PDCCH candidates cannot be allocated, the control section determines whether one or more PDCCH candidates out of the plurality of PDCCH candidates can be allocated.

7. The terminal according to claim 2, wherein the two PDCCH candidates are associated with two control resource sets.

8. The terminal according to claim 2, wherein the two PDCCH candidates are two repetitions.

9. The terminal according to claim 3, wherein the two PDCCH candidates are two repetitions.
